(19) United States
(12) Patent Application Publication
(10) Pub. No.: US 2026/0289822 A1
(43) Pub. Date: Sep. 24, 2026

(54) ADAPTIVE TOKEN REDUCTION MACHINE LEARNING MODELS

(71) Applicant: QUALCOMM Incorporated, San Diego, CA (US)

(72) Inventors: Adil KARJAUV, Diemen (NL); Elia PERUZZO, Amsterdam (NL); Amir GHODRATI, Amsterdam (NL); Amirhossein HABIBIAN, Amsterdam (NL)

(21) Appl. No.: 19/257,306

(22) Filed: Jul. 1, 2025

Related U.S. Application Data
(60) Provisional application No. 63/775,202, filed on Mar. 20, 2025.

(51) Int. Cl. G06T 9/00; G06T 7/246; G06V 20/40

(52) U.S. Cl. CPC G06T 9/00; G06T 7/248; G06V 20/46

(57) ABSTRACT

Systems and techniques are described for content generation. In some aspects, a computing device may process a video to obtain a tokenized video sequence. The video includes frames and spatially defined regions within the frames. The tokenized video sequence includes tokens representing the regions within the frames. The computing device may identify a first token associated with a first region of a first frame and a second token associated with a corresponding first region of a second frame. The computing device may determine, from the first token and the second token, a measurement of movement within the first region between the first frame and the second frame. The computing device may, based on the measurement of movement, compress the first token and the second token to generate a third token. The computing device can process the third token to generate output content.

### CROSS-REFERENCE TO RELATED APPLICATIONS

The present application claims the benefit of U.S. Provisional Application No. 63/775,202, filed Mar. 20, 2025, the contents of which is incorporated herein by reference in its entirety for all purposes.

### TECHNICAL FIELD

The disclosure relates generally to machine learning models. For example, aspects of the present disclosure include systems and techniques for adaptive token reduction in machine learning models or systems (e.g., for video diffusion transformer-based machine learning models).

### BACKGROUND

Machine learning systems (or models), such as neural networks (e.g., deep neural networks) are widely used for numerous applications, such as generative operations (e.g., to generate images, language/text outputs, etc.), object detection, object classification, object tracking, big data analysis, among others. For example, convolutional neural networks (CNNs) are able to extract high-level features, such as facial shapes, from an input image, and use these high-level features to output a probability that, for example, an input image includes a particular object.

A generative machine learning system can process data to generate desired output content from an input (e.g., a natural language input, input image(s) or video(s), a noise input such as for diffusion models, etc.). For instance, a language-based generative machine learning model (e.g., a large language model (LLM)) can generate natural language responses from natural language inputs and can incorporate various forms of data, such as audio, images and text. In some cases, a generative machine learning system can include an encoder that processes input features to generate output features (also referred to as embeddings or encodings) and can use the output features to generate relevant output content in a given form (e.g., in a natural language form, as generated images and/or video, as audio, explanation of the content, etc.). Generative ML systems are designed to assist users in solving problems, learning new information, and enhancing productivity.

### SUMMARY

The following presents a simplified summary relating to one or more aspects disclosed herein. Thus, the following summary should not be considered an extensive overview relating to all contemplated aspects, nor should the following summary be considered to identify key or critical elements relating to all contemplated aspects or to delineate the scope associated with any particular aspect. Accordingly, the following summary presents certain concepts relating to one or more aspects relating to the mechanisms disclosed herein in a simplified form to precede the detailed description presented below.

In some aspects, an apparatus for generating content is provided. The apparatus includes at least one memory and at least one processor coupled to the at least one memory and configured to: process a video to obtain a tokenized video sequence, wherein the video includes frames and spatially defined regions within the frames, and wherein the tokenized video sequence includes tokens representing the regions within the frames; identify a first token associated with a first region of a first frame and a second token associated with a corresponding first region of a second frame; determine, from the first token and the second token, a measurement of movement within the first region between the first frame and the second frame; based on the measurement of movement, compress the first token and the second token to generate a third token; and process the third token to generate output content.

In some aspects, a method for generating content is provided. The method includes: processing a video to obtain a tokenized video sequence, wherein the video includes frames and spatially defined regions within the frames, and wherein the tokenized video sequence includes tokens representing the regions within the frames; identifying a first token associated with a first region of a first frame and a second token associated with a corresponding first region of a second frame; determining, from the first token and the second token, a measurement of movement within the first region between the first frame and the second frame; based on the measurement of movement, compressing the first token and the second token to generate a third token; and processing the third token to generate output content.

In some aspects, a non-transitory computer-readable medium is provided that has stored thereon instructions that, when executed by one or more processors, cause the one or more processors to: process a video to obtain a tokenized video sequence, wherein the video includes frames and spatially defined regions within the frames, and wherein the tokenized video sequence includes tokens representing the regions within the frames; identify a first token associated with a first region of a first frame and a second token associated with a corresponding first region of a second frame; determine, from the first token and the second token, a measurement of movement within the first region between the first frame and the second frame; based on the measurement of movement, compress the first token and the second token to generate a third token; and process the third token to generate output content.

In some aspects, an apparatus for generating content is provided. The apparatus includes: means for processing a video to obtain a tokenized video sequence, wherein the video includes frames and spatially defined regions within the frames, and wherein the tokenized video sequence includes tokens representing the regions within the frames; means for identifying a first token associated with a first region of a first frame and a second token associated with a corresponding first region of a second frame; means for determining, from the first token and the second token, a measurement of movement within the first region between the first frame and the second frame; means for compressing, based on the measurement of movement, the first token and the second token to generate a third token; and means for processing the third token to generate output content.

In some aspects, one or more of the apparatuses described herein is, is part of, and/or includes a mobile device (e.g., a mobile telephone or other mobile devices) or other wireless communication device, a vehicle or a computing device or component of a vehicle, an extended reality (XR) device or system (e.g., a virtual reality (VR) device, an augmented reality (AR) device, or a mixed reality (MR) device), a wearable device, a camera, a personal computer, a laptop computer, a server computer or server device (e.g., an edge or cloud-based server, a personal computer acting as a server device, a mobile device such as a mobile phone acting as a server device, an XR device acting as a server device, a vehicle acting as a server device, a network router, or other device acting as a server device), another device, or a combination thereof. In some aspects, each apparatus can include a camera or multiple cameras for capturing one or more images. In some aspects, each apparatus can include a display or multiple displays for displaying one or more images, notifications, and/or other displayable data. In some aspects, each apparatus can include one or more sensors (e.g., one or more inertial measurement units (IMUs), such as one or more gyroscopes, one or more gyrometers, one or more accelerometers, or any combination thereof, and/or other sensor.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

The foregoing, together with other features and aspects, will become more apparent upon referring to the following specification, claims, and accompanying drawings.

### BRIEF DESCRIPTION OF THE DRAWINGS

Illustrative aspects of the present application are described in detail below with reference to the following drawing figures:

FIG. 1 illustrates an example implementation of a system, which may include a central processing unit (CPU), configured to perform one or more of the functions described herein;

FIG. 2 is a block diagram illustrating a multimodal generative machine learning system for generating natural language responses based on natural language input from a prompt and any additional information, in accordance with aspects of the disclosure;

FIG. 3 is a block diagram illustrating various approaches for using tokens to represent video, in accordance with aspects of the disclosure;

FIG. 4 is a block diagram illustrating a system for token reduction for video processing using machine learning models, in accordance with aspects of the disclosure;

FIG. 5 is a block diagram illustrating an adaptor for token reduction for video processing using machine learning models, in accordance with aspects of the disclosure;

FIG. 6 is a block diagram illustrating a system for down-sampling tokens for video processing using machine learning models, in accordance with aspects of the disclosure;

FIG. 7 is a block diagram illustrating a system for up-sampling tokens for video processing using machine learning models, in accordance with aspects of the disclosure;

FIG. 8 is a flow diagram illustrating an example of a process token reduction for video processing using machine learning models, in accordance with aspects of the disclosure;

FIG. 9 is a block diagram of an example transformer in accordance with some aspects of the disclosure; and

FIG. 10 shows an example of a computing system, which may be for example any computing device that may implement components of the system.

### DESCRIPTION

Certain aspects of this disclosure are provided below. Some of these aspects may be applied independently and some of them may be applied in combination as would be apparent to those of skill in the art. In the following description, for the purposes of explanation, specific details are set forth to provide a thorough understanding of aspects of the application. However, it will be apparent that various aspects may be practiced without these specific details. The figures and description are not intended to be restrictive.

The ensuing description provides example aspects only, and is not intended to limit the scope, applicability, or configuration of the disclosure. Rather, the ensuing description of the example aspects will provide those skilled in the art with an enabling description for implementing an example aspect. Various changes may be made in the function and arrangement of elements without departing from the spirit and scope of the application as set forth in the appended claims.

Machine learning models (also referred to as machine learning systems) can be trained to perform various functions and/or provide various types of outputs. For instance, some machine learning models can provide a conversational interface that uses natural language prompts as inputs, such as text or voice. In some examples, a user can provide an input prompt in natural language to the generative machine learning model, and the generative machine learning model can provide a response in natural language form. In other examples, machine learning models such as transformer models may receive as input a video sequence and/or generate a video sequence as output.

Transformer-based machine learning models (also referred to as transformer models or transformers) are very powerful for their scaling and expressivity. Transformers are becoming ubiquitous across various tasks due to their expressive power and scalability. Isotropic transformer models, in particular, offer structural simplicity, making large-scale training more feasible. Video generation has recently been transitioning to transformer-based models, driven by their success in capturing dependencies in visual data.

However, the computational cost of using transformer models can escalate dramatically with high dimensional inputs, such as videos, due to the quadratic scaling of attention operations. Moreover, high-dimensional inputs, such as images and videos, present a major challenge due to the quadratic cost of attention operations relative to sequence length. For instance, for video generation, for relatively short and low-quality videos a sequence may grow to 10,000 tokens.

Some techniques have been developed to reduce these complexities. For example, token merging techniques uses merging and unmerging operations to reduce number of tokens. Standard down-sampling techniques uniformly reduce the token numbers across all the spatial locations, overlooking these important differences. But these techniques suffer from deficiencies.

Systems, apparatuses, processes (also referred to as methods), and computer-readable media (collectively referred to as “systems and techniques”) are described herein for performing token reduction for machine learning models (or systems). For instance, the systems and techniques can perform token reduction for sequences of tokens that represent video data as used in machine learning systems. In some aspects, a video may be represented by different regions or patches. The systems and techniques can use an adaptive approach to reduce a number of tokens representing a given region while accounting for the strong temporal correlation of videos. In so doing, the systems and techniques can reduce the computational burden of attention without dramatically affecting visual quality in the context of video generation. Such a solution exploits the redundancy within video data, particularly along the temporal axis, as successive frames are often highly correlated.

Various aspects of the present disclosure are discussed in detail below. Further aspects and examples related to the present disclosure are included in Appendix A attached hereto, which is hereby incorporated by reference in its entirety and for all purposes. While specific implementations are discussed, it should be understood that this is done for illustration purposes only. A person skilled in the relevant art will recognize that other components and configurations may be used without parting from the spirit and scope of the disclosure.

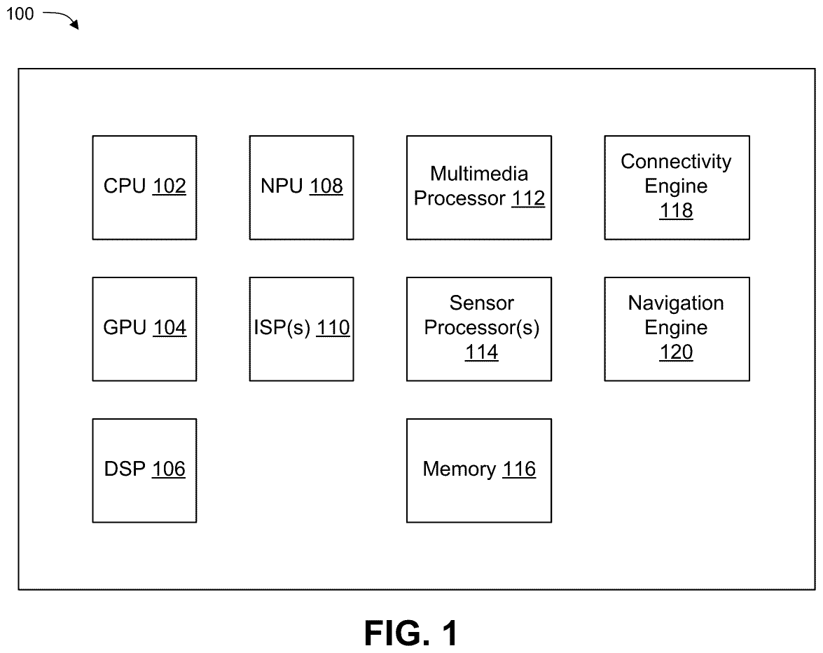

FIG. 1 illustrates an example implementation of a system 100, which may include a central processing unit (CPU), configured to perform one or more of the functions described herein. System 100, which may include a central processing unit (CPU 102) (which may be a multi-core CPU). Parameters or variables (e.g., neural signals and synaptic weights), system parameters associated with a computational device (e.g., neural network with weights), task information, among other information may be stored in a memory block associated with a neural processing unit (NPU 108), in a memory block associated with a CPU 102, in a memory block associated with a graphics processing unit (GPU 104), in a memory block associated with a digital signal processor (DSP 106), in a memory 116, and/or may be distributed across multiple blocks. Instructions executed at the CPU 102 may be loaded from a program memory associated with the CPU 102 or may be loaded from memory 116.

The system 100 may also include additional processing blocks tailored to specific functions, such as the GPU 104, the DSP 106, a connectivity engine 118, which may include fifth generation (5G) connectivity, fourth generation long term evolution (4G LTE) connectivity, Wi-Fi connectivity, USB connectivity, Bluetooth connectivity, and the like, and a multimedia processor 112 that may, for example, detect and recognize gestures. In one implementation, the NPU is implemented in the CPU 102, the DSP 106, and/or the GPU 104. The system 100 may also include one or more sensor processor(s) 114, one or more image signal processors (ISP(s) 110), and/or navigation engine 120, which may include a global positioning system. In some examples, the sensor processor(s) 114 can be associated with or connected to one or more sensors for providing sensor input(s) to the sensor processor(s) 114. For example, the one or more sensors and sensor processor(s) 114 can be provided in, coupled to, or otherwise associated with a same computing device.

The system 100 may be implemented as a system on a chip (SoC). The system 100 may be based on an Advanced Reduced Instruction Set Computer (RISC) Machine (ARM) instruction set. The system 100 and/or components thereof may be configured to perform machine learning techniques according to aspects of the present disclosure discussed herein. For example, the system 100 and/or components thereof may be configured to implement a machine learning model (e.g., a quantized trained machine learning model) as described herein and/or according to aspects of the present disclosure.

Machine learning (ML) can be considered a subset of artificial intelligence (AI). ML systems can include algorithms and statistical models that computer systems can use to perform various tasks by relying on patterns and inference, without the use of explicit instructions. In some examples, an ML system can be a neural network (also referred to as an artificial neural network), which may include an interconnected group of artificial neurons (e.g., neuron models). Neural networks may be used for various applications and/or devices, such as image and/or video coding, image analysis and/or computer vision applications, Internet Protocol (IP) cameras, Internet of Things (IoT) devices, autonomous vehicles, service robots, among others.

Individual nodes in a neural network may emulate biological neurons by taking input data and performing simple operations on the data. The results of the simple operations performed on the input data are selectively passed on to other neurons. Weight values are associated with each vector and node in the network, and these values constrain how input data is related to output data. For example, the input data of each node may be multiplied by a corresponding weight value, and the products may be summed. The sum of the products may be adjusted by an optional bias, and an activation function may be applied to the result, yielding the node's output signal or “output activation” (sometimes referred to as a feature map or an activation map). The weight values may initially be determined by an iterative flow of training data through the network (e.g., weight values are established during a training phase in which the network learns how to identify particular classes by their typical input data characteristics).

Different types of neural networks exist, such as convolutional neural networks (CNNs), recurrent neural networks (RNNs), generative adversarial networks (GANs), multilayer perceptron (MLP) neural networks, transformer neural networks, diffusion-based neural networks, among others. For instance, convolutional neural networks (CNNs) are a type of feed-forward artificial neural network. Convolutional neural networks may include collections of artificial neurons that each have a receptive field (e.g., a spatially localized region of an input space) and that collectively tile an input space. RNNs work on the principle of saving the output of a layer and feeding the output back to the input to help in predicting an outcome of the layer. A GAN is a form of generative neural network that can learn patterns in input data so that the neural network model can generate new synthetic outputs that reasonably could have been from the original dataset. A GAN can include two neural networks that operate together, including a generative neural network that generates a synthesized output and a discriminative neural network that evaluates the output for authenticity. In MLP neural networks, data may be fed into an input layer, and one or more hidden layers provide levels of abstraction to the data. Predictions may then be made on an output layer based on the abstracted data.

Deep learning (DL) is an example of a machine learning technique and can be considered a subset of ML. Many DL approaches are based on a neural network, such as an RNN or a CNN, and utilize multiple layers. The use of multiple layers in deep neural networks can permit progressively higher-level features to be extracted from a given input of raw data. For example, the output of a first layer of artificial neurons becomes an input to a second layer of artificial neurons, the output of a second layer of artificial neurons becomes an input to a third layer of artificial neurons, and so on. Layers that are located between the input and output of the overall deep neural network are often referred to as hidden layers. The hidden layers learn (e.g., are trained) to transform an intermediate input from a preceding layer into a slightly more abstract and composite representation that can be provided to a subsequent layer, until a final or desired representation is obtained as the final output of the deep neural network.

As noted above, a neural network is an example of a machine learning system, and can include an input layer, one or more hidden layers, and an output layer. Data is provided from input nodes of the input layer, processing is performed by hidden nodes of the one or more hidden layers, and an output is produced through output nodes of the output layer. Deep learning networks typically include multiple hidden layers. Each layer of the neural network can include feature maps or activation maps that can include artificial neurons (or nodes). A feature map can include a filter, a kernel, or the like. The nodes can include one or more weights used to indicate an importance of the nodes of one or more of the layers. In some cases, a deep learning network can have a series of many hidden layers, with early layers being used to determine simple and low-level characteristics of an input, and later layers building up a hierarchy of more complex and abstract characteristics.

A deep learning architecture may learn a hierarchy of features. If presented with visual data, for example, the first layer may learn to recognize relatively simple features, such as edges, in the input stream. In another example, if presented with auditory data, the first layer may learn to recognize spectral power in specific frequencies. The second layer, taking the output of the first layer as input, may learn to recognize combinations of features, such as simple shapes for visual data or combinations of sounds for auditory data. For instance, higher layers may learn to represent complex shapes in visual data or words in auditory data. Still higher layers may learn to recognize common visual objects or spoken phrases.

Deep learning architectures may perform especially well when applied to problems that have a natural hierarchical structure. For example, the classification of motorized vehicles may benefit from first learning to recognize wheels, windshields, and other features. These features may be combined at higher layers in different ways to recognize cars, trucks, and airplanes.

Neural networks may be designed with a variety of connectivity patterns. In feed-forward networks, information is passed from lower to higher layers, with each neuron in a given layer communicating to neurons in higher layers. A hierarchical representation may be built up in successive layers of a feed-forward network, as described above. Neural networks may also have recurrent or feedback (also called top-down) connections. In a recurrent connection, the output from a neuron in a given layer may be communicated to another neuron in the same layer. A recurrent architecture may be helpful in recognizing patterns that span more than one of the input data chunks that are delivered to the neural network in a sequence. A connection from a neuron in a given layer to a neuron in a lower layer is called a feedback (or top-down) connection. A network with many feedback connections may be helpful when the recognition of a high-level concept may aid in discriminating the particular low-level features of an input.

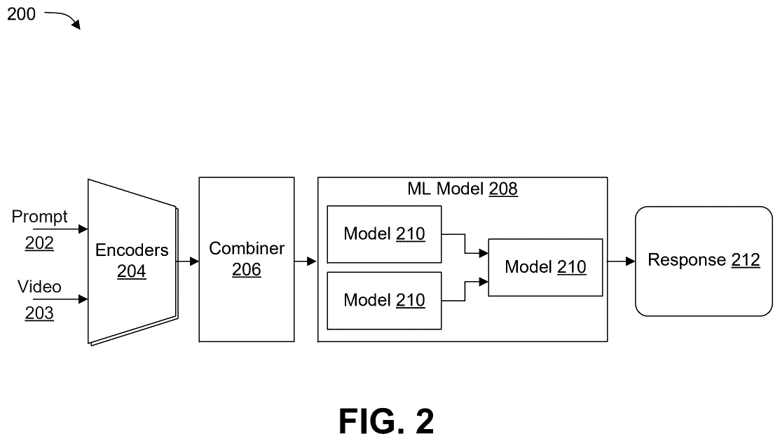

FIG. 2 is a block diagram illustrating a multimodal generative ML system 200 for generating responses based on input, in accordance with aspects of the disclosure. A multimodal machine learning system is a machine learning model that receives, processes, and outputs data in multiple forms. For example, the input prompt may include text, images, video, and/or audio.

For example, the multimodal generative ML system 200 includes encoders 204 that are each configured to encode different modes of content (e.g., text, images, audio, video etc.) into different tokens within a common embedding space. In an example, a text input such as prompt 202 and a video input such as video 203 are provided to the system 200. The text input is segmented based on different techniques (e.g., paragraph, sentence, etc.) and encoded by a text encoder (from the encoders 204) into tokens. The video input is encoded by a video encoder (from the encoders 204), for example, into tokens.

In another example, one or more images can be provided to an image encoder (from the encoders 204) that extracts features associated with the images or videos and generates tokens representing the visual features. In another example, audio can be provided to an audio encoder (from the encoders 204) that extracts features associated with the image and generates tokens representing the audio features. In the case of audio, the audio encoder can identify features that can include formants that characterize resonant frequencies in speech, rhythmic features related to timing and tempo, and harmonic features that describe the relationship between fundamental frequencies and their harmonics.

The different tokens from the plurality of encoders are provided to combiner 206. The combiner 206 can combine the tokens based on the order in which they are presented. For example, the input into the encoder may be an array of primitive values. A primitive value is an immutable data type provided by a programming language and includes values that represent a single piece of data (e.g., number, string, Boolean, etc.) rather than a complex object or reference. A non-limiting example prompt may include a byte array (e.g., an unsigned 8-byte integer array or uint8array), and another string. The byte array may be audio, images, or other content that can be processed by the encoders 204. In some aspects, the combiner 206 is configured to concatenate the different tokens in order based on the array to preserve the semantic order of features and provide the tokens to the generative machine learning model 208.

The machine learning model 208 is configured to receive the tokens and generate a response 212 based on the tokens and the prompt 202. The response 212 may be images, video, text, audio, or any combination thereof.

Machine learning model 208 may include one or more models 210 (e.g., transformer neural network(s), diffusion model(s), fully connected layer(s), multilayer perceptrons (MLPs), any combination thereof, and/or other models). The one or more models 210 of the machine learning model 208 are configured to process the tokens and extract different types of features that are relevant to the prompt 202. For example, the prompt 202 can be a query for a particular type of information. The one or more models of the machine learning model 208 can perform different tasks related to the query, such as writing code to perform a particular function, generating an image based on an input image with expressed modifications, generate an image without any input image, and so forth.

The machine learning model 208 may include different components, such as a featurization engine to identify different types of features, an inference engine to identify inferences within the text (e.g., pronoun usage and corresponding disambiguation functions), data retrieval engines (e.g., to identify features related to a particular concept observed by the machine learning model 208), and so forth. The machine learning model 208 may also include different types of models and engines to synthesize a coherent contextual output, such as to synthesize the input content and information that is responsive to tasks embedded within the text. For example, the machine learning model 208 may include a predictive output engine (not shown) that is configured to generate a sequence of words that is most likely contextually correct and to provide a coherent and contextually relevant answer. For instance, the predictive output generation engine can generate responses by sampling from the probability distribution of possible words and sequences based on patterns observed during training. The machine learning model 208 may also include a predictive output generation engine to generate multiple responses that are potentially relevant and coherent with respect to the prompt 202. The machine learning model 208 may also include an output validation engine configured to evaluate the generated responses based on certain criteria. Non-limiting examples of criteria to evaluate generated responses include relevance to the prompt, coherence, fluency, and adherence to specific guidelines or rules. Based on the evaluation, the output validation engine may select and output the most appropriate response.

As noted above, the machine learning model 208 may include various types of models (e.g., machine learning models), such as a transformer. A transformer is a neural network architecture that can be trained to perform one or more natural language processing (NLP) tasks, such as language translation, sentiment analysis, and text summarization. Conventional traditional recurrent neural networks (RNNs) process data in sequence. A transformer or transformer network can process input in parallel and can thus be faster and more efficient than sequential training and processing. In some aspects, a transformer can use a self-attention mechanism (e.g., one or more self-attention layers), which allows the transformer to identify the most relevant parts of the input text or content (e.g., audio or video). In some cases, a transformer can also use a cross-attention mechanism (e.g., one or more cross-attention blocks) which uses other content or data to determine the most relevant parts of the input. For example, cross-attention mechanisms are useful in sequential content such as a stream of data, such as optical flow, and other computer vision techniques.

A transformer neural network can include a multi-layer encoder-decoder architecture. For instance, an encoder of the encoder-decoder architecture can receive text as input, convert the input text into a sequence of hidden representations, and capture the meaning of the text at different levels of abstraction. A decoder of the encoder-decoder architecture can then process the representations output from the decoder to generate an output sequence, such as a text translation or a summary. The encoder and decoder can be trained together using supervised learning, unsupervised learning, or a combination of supervised and unsupervised learning techniques, such as maximum likelihood estimation and self-supervised pretraining. Illustrative examples of transformer engines include a BERT model, a Text-to-Text Transfer Transformer (T5), biomedical BERT (BioBERT), scientific BERT (SciBERT), and the SPECTER model for document-level representation learning. In some aspects, multiple transformer engines may be used to generate different tokens.

In some aspects, the machine learning model 208 may be executed using a neural engine (or multiple neural engines) for on-device execution, such as a neural processing unit (NPU), a neural signal processor (NSP), a digital signal processor (DSP), any combination thereof, and/or other neural engine. The neural engine can include a plurality of neural processing cores that are configured to parallelize operations associated with neural networks. A neural processing core can include arrays of multiply-accumulate (MAC) units and specialized instructions that are optimized for matrix operations, such as convolution and matrix multiplication. The neural processing core can receive input data and perform matrix transformations and nonlinear activation functions to break down and parallelize matrix operations. The neural processing core can perform tasks such as inference (e.g., runtime operation of a machine learning model) or training of deep learning models. The neural processing core can accelerate tasks by parallelization of larger computations that can be performed in parallel (e.g., matrix operations associated with neural networks). For instance, the neural engine may perform computer vision tasks such as object recognition. In some cases, the neural engine can be implemented based on various ML libraries such as PyTorch, which interfaces with the compute unified device architecture (CUDA) to parallelize operations.

As previously described, systems and techniques described herein can perform adaptive token reduction for token sequences (e.g., token sequences that represent video data). As explained below, the systems and techniques can use adaptive down-sampling to reduce token sequences representing a video sequence based on criteria such as a level of detected motion within the video sequence. The resulting simplified sequences of tokens can reduce resources needed to process the video sequence. For example, the systems and techniques can accelerate processing by transformer models for dense video prediction tasks, such as video generation. The systems and techniques can also enable generation of videos with comparable quality to previous approaches at a fraction of the computational cost and latency.

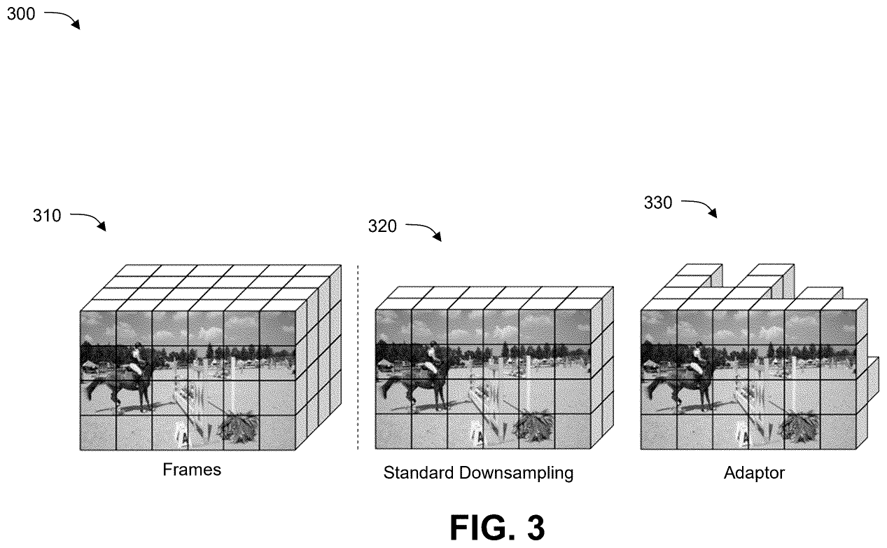

FIG. 3 is a block diagram illustrating various approaches 300 for using tokens to represent video, in accordance with aspects of the disclosure. FIG. 3 depicts token sequences 310, 320, and 330, each of which represent a sequence of video frames. Sequence 310 represents an original token sequence, whereas token sequences 320 and 330 represent different approaches to reducing tokens.

Token sequence 310 represents an original token sequence for a set of four video frames. The token sequence is represented as a cube, in which each cube represents a token. The spatial dimensions of the video are represented on the horizontal and vertical axes of the cube. As can be seen, there are twenty-four regions or patches of each frame (dimensions six by four). Each defined region of a video frame will typically have corresponding defined region in other video frames. The temporal dimension is represented a depth (e.g., front to back). In such an example, there are four frames of video, therefore, a depth of four. But other examples are possible.

By contrast, token sequence 320 represents a compressed sequence that uses a standard approach in which uniform down-sampling is applied. Each region is represented by a constant number of tokens. In such an example, each region has been down-sampled in the temporal direction from four to two. Therefore, the number of tokens needed is uniformly reduced over time. Relative to token sequence 310, the depth has been reduced uniformly (across all regions) from four to two.

By contrast, token sequence 330 is an example of a sequence generated using the techniques disclosed herein. Token sequence 330 maintains identical size in the horizontal and vertical dimensions but uses an adaptive approach to compression for each region. In this manner, a different amount of compression may be applied on a region-by-region basis, based on an identified level of movement between frames. For instance, regions with more movement can be compressed less, whereas regions with less movement can be compressed more. As can be seen, some regions are now represented by a depth of one or two, while others maintain a depth of four. The regions represented by a depth of four, i.e., the original depth, may include a higher amount of temporal motion such that compression would have adverse effects. Such an approach allows exploiting of redundancy present in video sequences (e.g., along a temporal axis), as successive frames are often highly correlated. For example, static regions or background pixels may remain consistent through a sequence of video.

As discussed further herein, a determination of a degree of compression to apply may be done by estimating a cosine similarity across the temporal axis for a given region. Compression may be achieved via down-sampling. After processing, by one or more intermediate transformer layers, the sequence may be up-sampled to the original size for further processing.

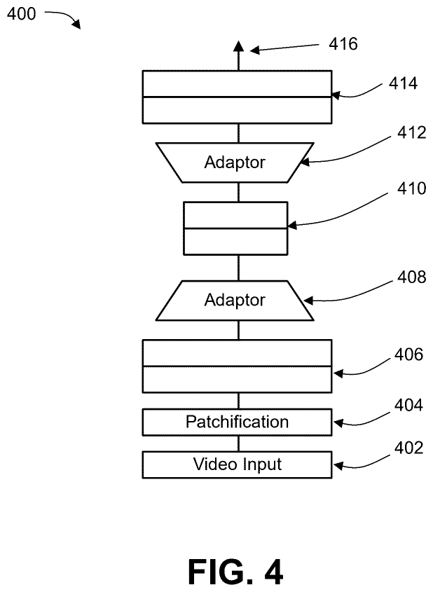

FIG. 4 is a block diagram illustrating a system 400 for token reduction for video processing using machine learning models, in accordance with aspects of the disclosure. In the isotropic transformer-based example depicted in system 400, video input 402 is compressed by using down-sampling by one or more adaptors for more efficient processing by one or more of the transformer layers before being up-sampled to its original length for further processing. In some cases, these blocks alternate between three operations: self-attention, cross-attention, and feedforward layers. Isotropic transformer models include a stack of L blocks, which alternate between three basic operations: self-attention, cross-attention, and feedforward layers.

Tokenization involves projecting the input data into a sequence of tokens (commonly referred to as patchification in the context of visual modalities). Given a video V∈R^{T}^{ₚ}^{×C×H}^{ₚ}^{×W}^{ₚ} the tokenizer splits it into a set of uniform patches which are projected into the model operating space C, resulting in a sequence of tokens: V∈R^{T}^{ₚ}^{×C}^{ₚ}^{×H}^{ₚ}^{×W}^{ₚ}. The tokens are then flattened in a sequence V∈R^{N×C}, with N=Tp. Hp·Wp. Isotropic architectures are characterized by a constant number of tokens N in all L blocks.

Patchification block 404 tokenizes video input 402 by projecting the video input 402 into a sequence of tokens. Patchification block 404 may involve using a variational auto encoder (VAE), which compresses the video input 402 spatially and/or temporally. In some cases, patchification block 404 divides break video frame into patches, or regions. Each region may be represented by one or more tokens. The patchification layer may transform the video from the pixel space to a latent space. For instance, a region of four pixels by four pixels may be transformed into a single pixel in the latent space.

Tokens generated by patchification block 404 are processed by one or more transformer layers 406. The transformer layers 406 therefore operate on uncompressed token sequences prior to compression of the token sequence in adaptor 408. The transformer layers 406 may operate in the latent space.

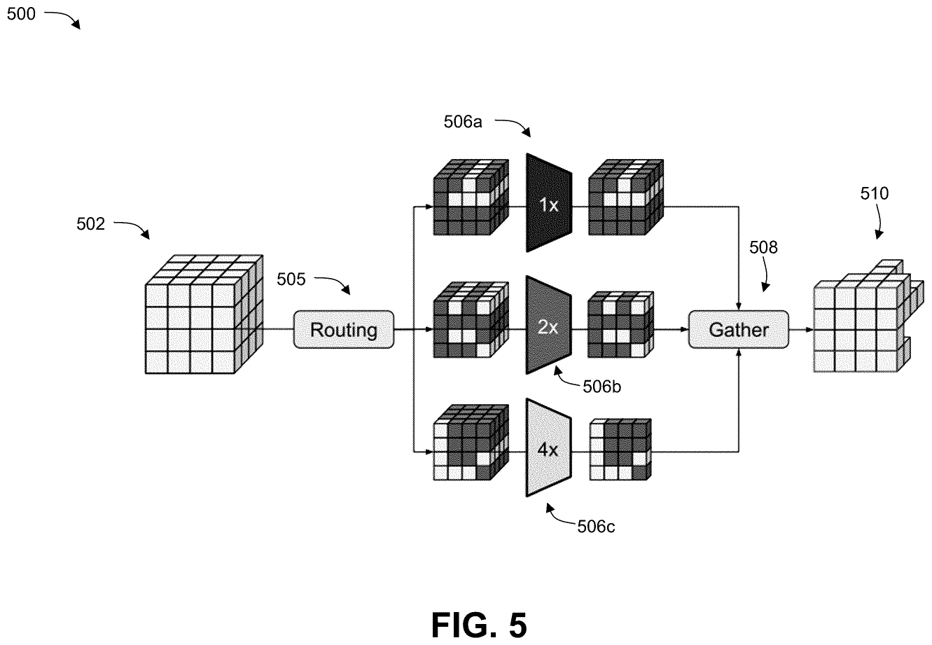

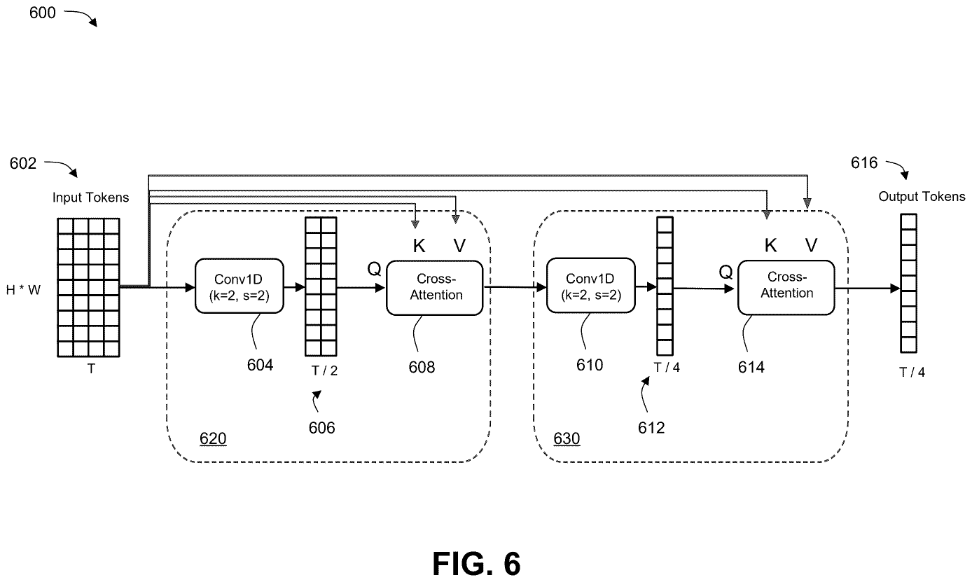

The resulting token output from transformer layer 406 is provided to adaptor 408 for compression. The functionality of adaptor 408 is discussed further with respect to FIG. 5. As discussed further, tokens corresponding to a region across various frames are analyzed to determine a level of motion, or movement, within the region between frames. The determination may be used to decide a suitable level of compression to be applied to tokens associated with that region. One example of compression is down-sampling, but other compression approaches are possible. Examples of operations relating to down-sampling are discussed further with respect to FIG. 6.

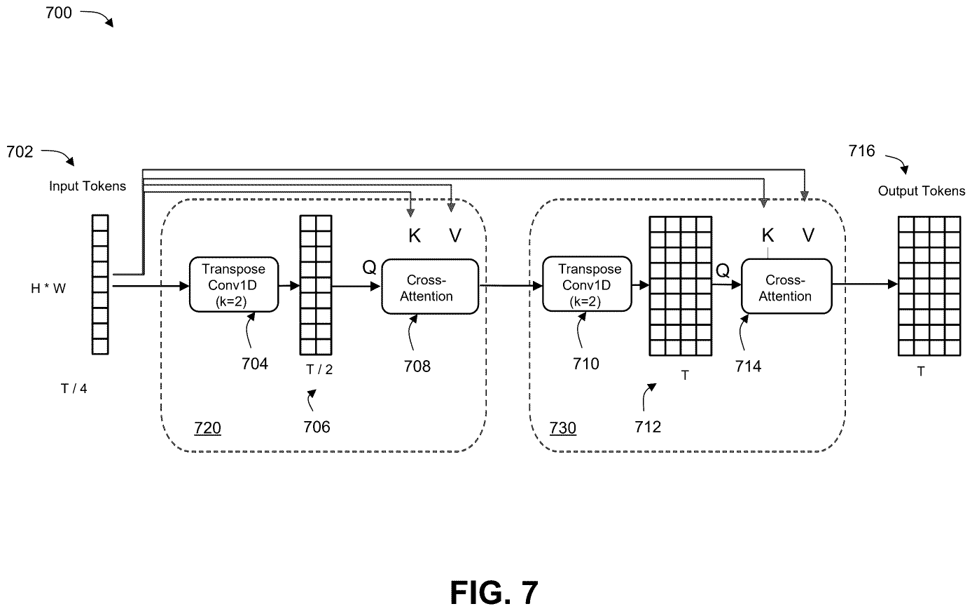

Continuing the example, the down-sampled video is provided to one or more transformer layers 410. Transformer layers 410 are required to process fewer tokens relative to previous solutions. The processed tokens from transformed layer 410 are provided to adaptor 412, which up-samples the tokens. Examples of operations are discussed further with respect to FIG. 7. The up-sampled tokens are provided to layer 414, which further processes the video and outputs a video sequence 416.

As depicted, system 400 includes transformer layers 406, 410, and 414. As depicted, resources needed for processing in layer 410 are reduced by inserting the adaptor 408 and adaptor 412 between the layers to reduce the token sequence being processed by layer 410. In system 400, multiple transformer models and/or layers are present. Each model may be formed of multiple blocks. But disclosed solutions may be applied to any transformer-based systems, resulting in a reduction in resources required for processing in one or more layers.

FIG. 5 is a block diagram illustrating an adaptor 500 for token reduction for video processing using machine learning models, in accordance with aspects of the disclosure. Adaptor 500 represents functionality of block 406 depicted in FIG. 4 in more detail.

In the example depicted, adaptor 500 receives input tokens 502, determines a suitable level of compression for each region within input tokens 502, and assigns a suitable level of compression, or down-sampling, to each region. Adaptor 500 is therefore configurable to selectively down-sample a token sequence representing video on a region-by-region basis.

The systems and techniques described herein can convert the transformer model into a non-isotropic architecture. For example, after l layers processing the full-length token sequence, systems and techniques involve downsampling that reduces the token count by a predefined compression ratio

$${r}_{tgt} = \frac{{N}^{′}}{N} where {N}^{′}$$

is the length of the compressed token sequence. The systems and techniques can then process the compressed token sequence using l′ transformer blocks before upsampling the tokens to the original token count. For example, vₗ can represent the sequence of tokens after the l-th transformer block, which can be reshaped to expose the temporal axis:

$${V}_{l} ∈ {R}^{{T}_{p} \times C \times {H}_{p} \times {W}_{p}}$$

Temporally consecutive tokens (e.g., tokens with the same (x, y) location but different timestep) are compressed. A routing function or mechanism (e.g., the routing mechanism 505 of FIG. 5) can be used to assign each Hp×Wp region to a specific compression ratio. In some aspects, the routing function or mechanism may be defined as:

$$g : {R}^{{T}_{p} \times C \times {H}_{p} \times {W}_{p}} \to {R}^{{H}_{p} \times {W}_{p} \times R}$$

For example, the routing function can assign one of the R predefined compression ratios, denoted as:

$${\{ {r}_{k} \}}_{K = 1}^{R}$$

to each spatial location in the input video. In some cases, the assignment function can be subject to a constraint to meet the desired compression ratio, which can be expressed as:

$${r}_{tgt} = \frac{1}{N} \cdot {\sum }_{i , j = 1}^{{H}_{p} , {W}_{p}} \frac{{T}_{p}}{{g}_{x y} ( {v}_{l} )}$$

Although several implementation strategies are possible, a heuristic-based assignment can be used. For example, the systems and techniques can estimate the compressibility of each spatial location by computing the average pairwise cosine similarity along the temporal axis, such as using the following:

$$s = \frac{1}{{T}_{p} - 1} {\sum }_{t = 1}^{{T}_{p} - 1} cos sim ( {v}_{l}^{t} , {v}_{l}^{t + 1} ) with s ϵ {R}^{{H}_{p} \times {W}_{p}}$$

The systems and techniques can then assign tokens proportionally to the similarity scores s. In some aspects, as the denoising process gradually transforms random noise into the final output, applying different compression ratios too early can be detrimental, as the content has not yet emerged. In such aspects, a hyperparameter can be introduced that activates adaptive downsampling after t denoising steps, during which standard downsampling is used. In some cases, downsampling can be applied after l transformer blocks processing the original token sequence and, symmetrically, upsampling can be introduced l layers before the output. To preserve information, tokens may be cached before the downsampling stage and reintroduced via skip connections during the upsampling stage.

With f denoting the learnable downsampling operation, the network can perform multiple downsampling stages within a shared architecture. A cascade of tokens can be extracted at varying temporal resolutions, such as follows:

$$f : {R}^{{T}_{p} \times C \times {H}_{p} \times {W}_{p}} \to {R}^{R \times \frac{{W}_{p}}{{r}_{k}} \times C \times {H}_{p} \times {W}_{p}} , with {\{ {r}_{k} \}}_{K = 1}^{R}$$

the compressed sequence at the k-th rate of temporal downsampling. Tokens can be collected at varying temporal compression ratios using the spatial assignment function, forming the compressed sequence:

$${{\tilde{v}}_{l} = ‖}_{k = 1}^{R} {f}_{x y} ( {v}_{l} ; {r}_{k} ) s . t . {g}_{x y} ( {v}_{l} ) = {r}_{k}$$

Where ∥ denotes concatenation, f_{xy}(vₗ; rₖ) represents downsampled tokens for compression ratio rk, and g_{xy}(vₗ) defines the spatial locations assigned to rₖ.

After downsampling, each compressed token may represent a different number of input tokens, impacting softmax attention. Tokens representing more inputs will proportionally contribute less. To compensate, the systems and techniques can apply a proportional attention mechanism is applied, adding a bias term before softmax equal to the log of each token's count:

$${v = ‖}_{k = 1}^{R} log ( {r}_{k} ) s . t . {g}_{x y} ( {v}_{l} ) = {r}_{k} .$$

For instance, with this correction term, the operation can be considered as equivalent to having rₖ copies of the merged token.

Input tokens 502 may be generated by patchification block 404. The input tokens 502 are received, and each region of video is analyzed with respect to corresponding areas in subsequent frames to determine a level of movement that is present between frames. For instance, some a region with a background may not have much movement, and therefore, the system may apply a higher level of compression without performance degradation. By contrast, a region with movement, for example due to a person moving or a camera panning, may require a greater level of compression to maintain a suitable level of quality.

A level of compression may be determined by comparing tokens associated with a particular region across the temporal dimension. In some aspects, cosine similarity may be used to compare the tokens. In one illustrative example, if there are four tokens in the temporal dimension, a cosine similarity may be computed between each pair of neighboring tokens in the time dimension. For example, a cosine similarity may be computed between the first and second token, the second and third token, and the third and fourth token, and so forth. The resulting three cosine similarities may be averaged to obtain a number that is then used to determine an amount of suitable compression.

If a cosine similarity is greater than a threshold, then a higher rate of video compression may be used. By contrast, if the cosine similarity is lower than the threshold, then a lower rate of compression may be used. Other examples are possible. For instance, if there are three levels of compression available, then three thresholds for comparing cosine similarity values may be used. In some cases, no compression is used. Similarity metrics other than cosine similarity can be used to determine similarity between tokens (e.g., between two vectors of values), such as Euclidean distance.

Based on the identified level of compression, tokens associated with the region are routed by routing mechanism 505 to an appropriate down-sampling block 506a-c. While down-sampling blocks are depicted, any number of blocks are possible. As depicted, down-sampling block 506a does not down-sample, whereas down-sampling block 506b down-samples by a factor of two, and down-sampling block 506c down-samples by a factor of four. Other down-sampling ratios are possible.

Continuing the example, the down-sampled outputs are gathered and are reintegrated at gather block 508, resulted in an output token sequence 510. As explained further with respect to FIG. 6, token sequence reduction may be implemented by down-sampling, which may involve convolution and/or cross-attention functionality.

FIG. 6 is a block diagram illustrating a system 600 for down-sampling tokens for video processing using machine learning models, in accordance with aspects of the disclosure. In the example depicted in system 600, input tokens 602 are obtained and processed by two down-sampling blocks 620 and 630, resulting in down-sampled tokens 616. In the example depicted, the input tokens 602 have a depth T, are down-sampled to half the depth T/2 by block 620, by half again, to depth T/4 by block 630, and are output as output tokens 616. Accordingly, each down-sampling block 620 and 630 reduces a depth of the token sequence by a factor of two.

Each down-sampling block includes a convolutional block and a cross-attention block. For instance, down-sampling block 620 includes convolutional block 604 and cross-attention block 608, and down-sampling block 630 includes convolutional block 610 and cross-attention block 614.

Convolutional blocks 604 and 610 perform standard convolution. In standard convolution, a filter (e.g., a kernel) slides over an input feature map, and each output value is computed as a weighted sum of the values in the input region covered by the filter. The convolutional operation typically reduces the spatial dimensions (height and width) of the output. The output of convolutional block 604 is a sequence of tokens 606 having dimension T/2, whereas the output of convolutional block 610 is a sequence of tokens 612 having dimensions T/4.

Cross-attention allows one set of features (e.g., from one modality or sequence) to focus on another set of features (e.g., from a different modality or sequence). Cross-attention allows the model to learn dependencies between different parts of the data (for example, relating words in one sentence to words in another sentence or linking features from an image to text). In cross-attention, the query (Q) comes from one source (e.g., one sequence), and the key (K) and value (V) come from another source (e.g., a different sequence). The attention mechanism computes a weighted sum of the values based on how much focus the model should give to each part of the other source (using the keys and queries to calculate the attention scores).

Continuing the example, the output of convolutional blocks 604 and 610 are provided as queries to the cross-attention blocks 608 and 614 respectively. The cross-attention blocks also receive the keys and values from the input tokens 602 and generate output tokens.

In an example, for a rate of compression of two, four tokens may be compressed into two tokens. The reduction is therefore one token per spatial location. In such cases, a kernel size of the deconvolution may be two and a stride may be two. Then, the resulting tokens are provided to the cross-attention block as a query, which also receives keys and values. In such an example, the cross-attention is performed between the two queries originating from the two tokens originating from the convolutional down-sampling, and the corresponding keys and values.

FIG. 7 is a block diagram illustrating a system for up-sampling tokens for video processing using machine learning models, in accordance with aspects of the disclosure. In the example depicted in system 700, input tokens 702 are obtained and processed by two up-sampling blocks 720 and 730, resulting in up-sampled tokens 616.

Each up-sampling block includes a transpose convolutional block and a cross-attention block. For instance, up-sampling block 720 includes transpose convolutional block 704 and cross-attention block 708, and up-sampling block 730 includes transpose convolutional block 710 and cross-attention block 714.

Transpose convolution block 704 receives as input tokens 702, which have depth T/4, and generates a sequence of tokens 706 which have a depth of T/2. In transpose convolution, the goal is to map a smaller feature map to a larger one by inserting zeros (or applying some other technique) between the input values to spread out the values before applying the convolution operation. The sequence of tokens 706 is provided as a query into the cross-attention block 708, which also receives keys and values from input tokens 702.

Similarly, transpose convolution block 710 receives as input the output from block 720, including tokens of depth T/2, and generates tokens 712, which have a depth of T. Tokens 712 are provided as a query into the cross-attention block 714, which also receives keys and values from input tokens 702. The cross-attention block 714 processes the query, keys, and values to generate output tokens 716. The resulting output tokens 716 have a depth T.

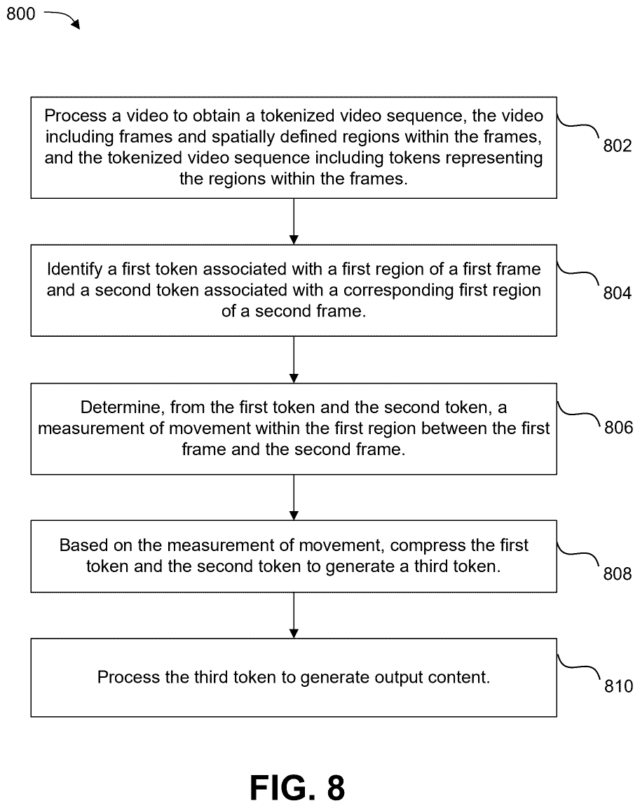

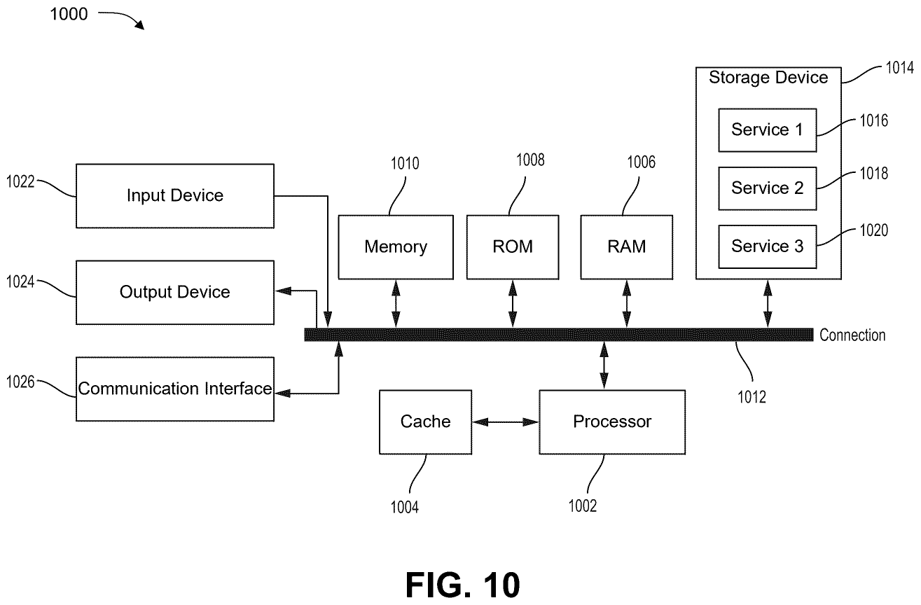

FIG. 8 is a flow diagram illustrating an example of a process token reduction for video processing using machine learning models, in accordance with aspects of the disclosure. The process 800 (or any other described herein) can be performed by a computing device (or apparatus) or a component (e.g., the system 400 of FIG. 4, the adaptor 500 of FIG. 5, the system 600 of FIG. 6, the system 700 of FIG. 7, one or more chipsets, a system-on-chip (SoC), one or more processors such as one or more central processing units (CPUs), graphics processing units (GPUs), digital signal processors (DSPs), neural processing units (NPUs), neural signal processors (NSPs), microcontrollers, ASICs, FPGAs, programmable logic devices, discrete gates or transistor logic components, discrete hardware components, etc., an ML system such as a neural network model, any combination thereof, and/or other component or system) of the computing device. The operations of the process 800 may be implemented as software components that are executed and run on one or more processors (e.g., CPU, GPU, DSP, NPU or neural engine, SoC, the processor 1002 of FIG. 10, and/or other processor(s)).

In some aspects, at block 802, the computing system may process a video to obtain a tokenized video sequence. The video can include frames and spatially defined regions within the frames, and the tokenized video sequence can include tokens representing the regions within the frames.

In some aspects, at block 804, the computing system may identify a first token associated with a first region of a first frame and a second token associated with a corresponding first region of a second frame.

In some aspects, at block 806, the computing system may determine (e.g., calculate, compute, etc.), from the first token and the second token, a measurement of movement within the first region between the first frame and the second frame. The measurement of movement may be based on a cosine similarity between the first token and the second token. For instance, the computing system may determine the cosine similarity between the first token and the second token, compare the cosine similarity against a threshold, and compress the first token and the second token based on the cosine similarity being less than the threshold.

In some aspects, at block 808, the computing system may, based on the measurement of movement, compress the first token and the second token to generate a third token. Compression may involve down-sampling. For instance, to compress the first token and the second token, the computing system may down-sample the first token and the second token to generate the third token. In another example, compression may involve applying a convolutional encoder to the first token and the second token to generate an intermediate token and applying a cross-attention mechanism to the intermediate token and to keys and values generated from the first token and the second token to generate the third token.

In some aspects, at block 810, the computing system may process the third token to generate output content.

In an aspect, the computing system may process the tokenized video sequence using a first layer of a transformer model. To process the third token, the computing system may process the third token using a second layer of the transformer model.

In an aspect, the computing system may up-sample the third token to generate an additional first token and an additional second token and process the additional first token and an additional second token using a third layer of the transformer model.

In an aspect, the computing system may apply a transpose convolution to the third token to generate intermediate tokens and apply a cross-attention mechanism to the intermediate tokens and to keys and values generated from the third token to generate the additional first token and additional second token.

In an aspect, tokenized video sequence may include a third token associated with a second region of the first frame and a fourth token associated with the second region of the second frame. The computing system may be configured to determine, from the third token and the fourth token, an additional measurement of movement of second region between the first frame and the second frame. The computing system may be further configured to, based on the additional measurement of movement, compress the third token and the fourth token according to an additional level of compression to generate a fifth token. The additional level of compression is different from a level of compression applied to the first token and the second token.

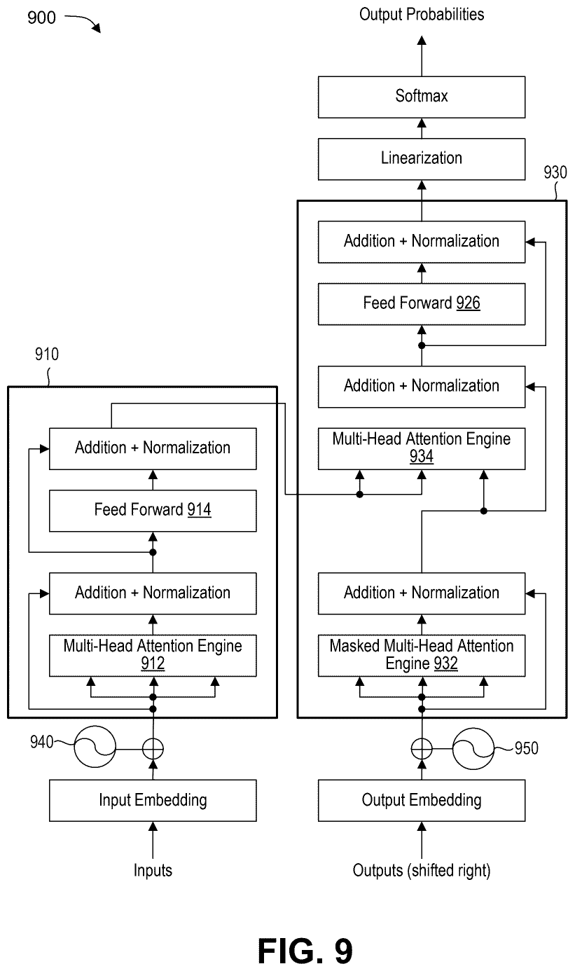

FIG. 9 is a block diagram of an example transformer in accordance with some aspects of the disclosure. In a convolutional neural network (CNN) model, the number of operations required to relate signals from two arbitrary input or output positions grows in the distance between positions, which makes learning dependencies at different distant positions challenging for a CNN model. The transformer 900 reduces the operations of learning dependencies by using an encoder 910 and a decoder 930 that implements an attention mechanism at different positions of a single sequence to compute a representation of that sequence. An attention function can be described as mapping a query and a set of key-value pairs to an output, where the query, keys, values, and output are all vectors. The output is computed as a weighted sum of the values, where the weight assigned to each value is computed by a compatibility function of the query with the corresponding key.

In some examples of a transformer, the encoder 910 is composed of a stack of six identical layers and each layer has two sub-layers. The first sub-layer is a multi-head self-attention engine 912, and the second sub-layer is a fully connected feed-forward network 914. A residual connection (not shown) connects around each of the sub-layers followed by normalization.

In the example of the transformer 900, the decoder 930 is also composed of a stack of six identical layers. The decoder also includes a masked multi-head self-attention engine 932, a multi-head attention engine 934 over the output of encoder 910, and a fully connected feed-forward network 926. Each layer includes a residual connection (not shown) around the layer, which is followed by layer normalization. The masked multi-head self-attention engine 932 is masked to prevent positions from attending to subsequent positions and ensures that the predictions at position i can depend only on the known outputs at positions less than i (e.g., auto-regression).

In the transformer 900, the queries, keys, and values are linearly projected by a multi-head attention engine into learned linear projects, and then attention is performed in parallel on each of the learned linear projects, which are concatenated and then projected into final values.

The transformer also includes a positional encoder 940 to encode positions because the model does not contain recurrence and convolution and relative or absolute position of the tokens is needed. For example, the positional encodings are added to the input embeddings at the bottom layer of the encoder 910 and the decoder 930. The positional encodings are summed with the embeddings because the positional encodings and embeddings have the same dimensions. A corresponding position decoder 950 is configured to decode the positions of the embeddings for the decoder 930.

In some aspects, the transformer 900 uses self-attention mechanisms to selectively weigh the importance of different parts of an input sequence during processing and allows the model to attend to different parts of the input sequence while generating the output. The input sequence is first embedded into vectors and then passed through multiple layers of self-attention and feed-forward networks. The transformer 900 can process input sequences of variable length, making it well-suited for natural language processing tasks where input lengths can vary greatly. Additionally, the self-attention mechanism allows the transformer 900 to capture long-range dependencies between words in the input sequence, which is difficult for RNNs and CNNs. The transformer with self-attention has achieved results in several natural language processing tasks that are beyond the capabilities of other neural networks and has become a popular choice for language and text applications. For example, the various large language models, such as a generative pretrained transformer (e.g., ChatGPT, etc.) and other current models are types of transformer networks.

FIG. 10 is a diagram illustrating an example of a system for implementing certain aspects of the present technology. In particular, FIG. 10 illustrates an example of a computing system 1000, which can be for example any computing device making up an internal computing system, a remote computing system, a mobile device, an XR device, a camera, or any component thereof in which the components of the system are in communication with each other using a connection 1012. The computing system 1000 can be used to implement any of the systems or components described herein, such as system 400 of FIG. 4, the adaptor 500 of FIG. 5, the system 600 of FIG. 6, the system 700 of FIG. 7, etc. The connection 1012 can be a physical connection using a bus, or a direct connection into the processor 1002, such as in a chipset architecture. The connection 1012 can also be a virtual connection, networked connection, or logical connection.

In some aspects, the computing system 1000 is a distributed system in which the functions described in this disclosure can be distributed within a datacenter, multiple data centers, a peer network, etc. In some aspects, one or more of the described system components represents many such components each performing some or all of the function for which the component is described. In some aspects, the components can be physical or virtual devices.

An example computing system 1000 includes at least one processing unit (a central processing unit (CPU) or processor) 1002 and a connection 1012 that couples various system components including a system memory 1010, such as ROM 1008 and RAM 1006 to the processor 1002. The computing system 1000 can include a cache 1004 of high-speed memory connected directly with, in close proximity to, or integrated as part of the processor 1002.

The processor 1002 can include any general purpose processor and a hardware service or software service, such as services 1016, 1018, and 1020 stored in the storage device 1014, configured to control the processor 1002 as well as a special-purpose processor where software instructions are incorporated into the actual processor design. The processor 1002 may essentially be a completely self-contained computing system, containing multiple cores or processors, a bus, memory controller, cache, etc. A multi-core processor may be symmetric or asymmetric.

To enable user interaction, the computing system 1000 includes an input device 1022, which can represent any number of input mechanisms, such as a microphone for speech, a touch-sensitive screen for gesture or graphical input, keyboard, mouse, motion input, speech, etc. The computing system 1000 can also include an output device 1024, which can be one or more of a number of output mechanisms. In some instances, multimodal systems can enable a user to provide multiple types of input/output to communicate with the computing system 1000. The computing system 1000 can include communications interface 1026, which can generally govern and manage the user input and system output. The communication interface may perform or facilitate receipt and/or transmission wired or wireless communications using wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a Bluetooth® wireless signal transfer, a BLE wireless signal transfer, an IBEACON® wireless signal transfer, an RFID wireless signal transfer, near-field communications (NFC) wireless signal transfer, dedicated short range communication (DSRC) wireless signal transfer, 802.11 WiFi wireless signal transfer, WLAN signal transfer, Visible Light Communication (VLC), Worldwide Interoperability for Microwave Access (WiMAX), IR communication wireless signal transfer, Public Switched Telephone Network (PSTN) signal transfer, Integrated Services Digital Network (ISDN) signal transfer, 3G/4G/5G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof. The communications interface 1026 may also include one or more Global Navigation Satellite System (GNSS) receivers or transceivers that are used to determine a location of the computing system 1000 based on receipt of one or more signals from one or more satellites associated with one or more GNSS systems. GNSS systems include, but are not limited to, the US-based GPS, the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

The storage device 1014 can be a non-volatile and/or non-transitory and/or computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another IC chip/card, RAM, static RAM (SRAM), dynamic RAM (DRAM), ROM, programmable read-only memory (PROM), erasable programmable read-only memory (EPROM), electrically erasable programmable read-only memory (EEPROM), flash EPROM (FLASHEPROM), cache memory (L1/L2/L3/L4/L5/L #), resistive random-access memory (RRAM/ReRAM), phase change memory (PCM), spin transfer torque RAM (STT-RAM), another memory chip or cartridge, and/or a combination thereof.

The storage device 1014 can include software services, servers, services, etc., that when the code that defines such software is executed by the processor 1002, it causes the system to perform a function. In some aspects, a hardware service that performs a particular function can include the software component stored in a computer-readable medium in connection with the necessary hardware components, such as the processor 1002, the connection 1012, the output device 1024, etc., to carry out the function. The term “computer-readable medium” includes, but is not limited to, portable or non-portable storage devices, optical storage devices, and various other mediums capable of storing, containing, or carrying instruction(s) and/or data. A computer-readable medium may include a non-transitory medium in which data can be stored and that does not include carrier waves and/or transitory electronic signals propagating wirelessly or over wired connections. Examples of a non-transitory medium may include, but are not limited to, a magnetic disk or tape, optical storage media such as CD or DVD, flash memory, memory or memory devices. A computer-readable medium may have stored thereon code and/or machine-executable instructions that may represent a procedure, a function, a subprogram, a program, a routine, a subroutine, a module, an engine, a software package, a class, or any combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted via any suitable means including memory sharing, message passing, token passing, network transmission, or the like.

In some examples, the processes described herein (e.g., process 800, and/or other process described herein) may be performed by a computing device or apparatus. In some examples, the process 800 can be performed by a computing device having a computing architecture of the computing system 1000 shown in FIG. 10.

Specific details are provided in the description above to provide a thorough understanding of the aspects and examples provided herein, but those skilled in the art will recognize that the application is not limited thereto. Thus, while illustrative aspects of the application have been described in detail herein, it is to be understood that the inventive concepts may be otherwise variously embodied and employed, and that the appended claims are intended to be construed to include such variations, except as limited by the prior art. Various features and aspects of the above-described application may be used individually or jointly. Further, aspects may be utilized in any number of environments and applications beyond those described herein without departing from the broader scope of the specification. The specification and drawings are, accordingly, to be regarded as illustrative rather than restrictive. For the purposes of illustration, methods were described in a particular order. It should be appreciated that in alternate aspects, the methods may be performed in a different order than that described.

For clarity of explanation, in some instances the present technology may be presented as including individual functional blocks including devices, device components, steps or routines in a method embodied in software, or combinations of hardware and software. Additional components may be used other than those shown in the figures and/or described herein. For example, circuits, systems, networks, processes, and other components may be shown as components in block diagram form in order not to obscure the aspects in unnecessary detail. In other instances, well-known circuits, processes, algorithms, structures, and techniques may be shown without unnecessary detail in order to avoid obscuring the aspects.

Further, those of skill in the art will appreciate that the various illustrative logical blocks, modules, engines, circuits, and algorithm steps described in connection with the aspects disclosed herein may be implemented as electronic hardware, computer software, or combinations of both. To clearly illustrate this interchangeability of hardware and software, various illustrative components, blocks, modules, engines, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

Individual aspects may be described above as a process or method which is depicted as a flowchart, a flow diagram, a data flow diagram, a structure diagram, or a block diagram. Although a flowchart may describe the operations as a sequential process, many of the operations may be performed in parallel or concurrently. In addition, the order of the operations may be re-arranged. A process is terminated when its operations are completed but could have additional steps not included in a figure. A process may correspond to a method, a function, a procedure, a subroutine, a subprogram, etc. When a process corresponds to a function, its termination may correspond to a return of the function to the calling function or the main function.

Processes and methods according to the above-described examples may be implemented using computer-executable instructions that are stored or otherwise available from computer-readable media. Such instructions may include, for example, instructions and data which cause or otherwise configure a general purpose computer, special purpose computer, or a processing device to perform a certain function or group of functions. Portions of computer resources used may be accessible over a network. The computer executable instructions may be, for example, binaries, intermediate format instructions such as assembly language, firmware, source code. Examples of computer-readable media that may be used to store instructions, information used, and/or information created during methods according to described examples include magnetic or optical disks, flash memory, USB devices provided with non-volatile memory, networked storage devices, and so on.

In some aspects the computer-readable storage devices, mediums, and memories may include a cable or wireless signal containing a bitstream and the like. However, when mentioned, non-transitory computer-readable storage media expressly exclude media such as energy, carrier signals, electromagnetic waves, and signals per se.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof, in some cases depending in part on the particular application, in part on the desired design, in part on the corresponding technology, etc.

The various illustrative logical blocks, modules, engines, and circuits described in connection with the aspects disclosed herein may be implemented or performed using hardware, software, firmware, middleware, microcode, hardware description languages, or any combination thereof, and may take any of a variety of form factors. When implemented in software, firmware, middleware, or microcode, the program code or code segments to perform the necessary tasks (e.g., a computer-program product) may be stored in a computer-readable or machine-readable medium. A processor(s) may perform the necessary tasks. Examples of form factors include laptops, smart phones, mobile phones, tablet devices or other small form factor personal computers, personal digital assistants, rackmount devices, standalone devices, and so on. Functionality described herein also may be embodied in peripherals or add-in cards. Such functionality may also be implemented on a circuit board among different chips or different processes executing in a single device, by way of further example.

The instructions, media for conveying such instructions, computing resources for executing them, and other structures for supporting such computing resources are example means for providing the functions described in the disclosure.

The techniques described herein may also be implemented in electronic hardware, computer software, firmware, or any combination thereof. Such techniques may be implemented in any of a variety of devices such as general purposes computers, wireless communication device handsets, or integrated circuit devices having multiple uses including application in wireless communication device handsets and other devices. Any features described as modules, engines, or components may be implemented together in an integrated logic device or separately as discrete but interoperable logic devices. If implemented in software, the techniques may be realized at least in part by a computer-readable data storage medium including program code including instructions that, when executed, performs one or more of the methods, algorithms, and/or operations described above. The computer-readable data storage medium may form part of a computer program product, which may include packaging materials. The computer-readable medium may include memory or data storage media, such as random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The techniques additionally, or alternatively, may be realized at least in part by a computer-readable communication medium that carries or communicates program code in the form of instructions or data structures and that may be accessed, read, and/or executed by a computer, such as propagated signals or waves.

The program code may be executed by a processor, which may include one or more processors, such as one or more digital signal processors (DSPs), general purpose microprocessors, an application specific integrated circuits (ASICs), field programmable logic arrays (FPGAs), or other equivalent integrated or discrete logic circuitry. Such a processor may be configured to perform any of the techniques described in this disclosure. A general-purpose processor may be a microprocessor; but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. Accordingly, the term “processor,” as used herein may refer to any of the foregoing structure, any combination of the foregoing structure, or any other structure or apparatus suitable for implementation of the techniques described herein.

One of ordinary skill will appreciate that the less than (“<”) and greater than (“>”) symbols or terminology used herein may be replaced with less than or equal to (“≤”) and greater than or equal to (“≥”) symbols, respectively, without departing from the scope of this description.

Where components are described as being “configured to” perform certain operations, such configuration may be accomplished, for example, by designing electronic circuits or other hardware to perform the operation, by programming programmable electronic circuits (e.g., microprocessors, or other suitable electronic circuits) to perform the operation, or any combination thereof.

The phrase “coupled to” or “communicatively coupled to” refers to any component that is physically connected to another component either directly or indirectly, and/or any component that is in communication with another component (e.g., connected to the other component over a wired or wireless connection, and/or other suitable communication interface) either directly or indirectly.

Claim language or other language reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, A and B and C, or any duplicate information or data (e.g., A and A, B and B, C and C, A and A and B, and so on), or any other ordering, duplication, or combination of A, B, and C. The language “at least one of” a set and/or “one or more” of a set does not limit the set to the items listed in the set. For example, claim language reciting “at least one of A and B” or “at least one of A or B” may mean A, B, or A and B, and may additionally include items not listed in the set of A and B. The phrases “at least one” and “one or more” are used interchangeably herein.

Claim language or other language reciting “at least one processor configured to,” “at least one processor being configured to,” “one or more processors configured to,” “one or more processors being configured to,” or the like indicates that one processor or multiple processors (in any combination) can perform the associated operation(s). For example, claim language reciting “at least one processor configured to: X, Y, and Z” means a single processor can be used to perform operations X, Y, and Z; or that multiple processors are each tasked with a certain subset of operations X, Y, and Z such that together the multiple processors perform X, Y, and Z; or that a group of multiple processors work together to perform operations X, Y, and Z. In another example, claim language reciting “at least one processor configured to: X, Y, and Z” can mean that any single processor may only perform at least a subset of operations X, Y, and Z.

Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions.

Where reference is made to an entity (e.g., any entity or device described herein) performing functions or being configured to perform functions (e.g., steps of a method), the entity may be configured to cause one or more elements (individually or collectively) to perform the functions. The one or more components of the entity may include at least one memory, at least one processor, at least one communication interface, another component configured to perform one or more (or all) of the functions, and/or any combination thereof. Where reference to the entity performing functions, the entity may be configured to cause one component to perform all functions, or to cause more than one component to collectively perform the functions. When the entity is configured to cause more than one component to collectively perform the functions, each function need not be performed by each of those components (e.g., different functions may be performed by different components) and/or each function need not be performed in whole by only one component (e.g., different components may perform different sub-functions of a function).

Illustrative aspects of the disclosure include:

Aspect 1. An apparatus for generating content, comprising: at least one memory; and at least one processor coupled to the at least one memory and configured to: process a video to obtain a tokenized video sequence, wherein the video comprises frames and spatially defined regions within the frames, and wherein the tokenized video sequence comprises tokens representing the regions within the frames; identify a first token associated with a first region of a first frame and a second token associated with a corresponding first region of a second frame; determine, from the first token and the second token, a measurement of movement within the first region between the first frame and the second frame; based on the measurement of movement, compress the first token and the second token to generate a third token; and process the third token to generate output content.

Aspect 2. The apparatus of Aspect 1, wherein, to compress the first token and the second token, the at least one processor is configured to down-sample the first token and the second token to generate the third token.

Aspect 3. The apparatus of any of Aspects 1 or 2, wherein, to compress the first token and the second token, the at least one processor is configured to: apply a convolutional encoder to the first token and the second token to generate an intermediate token; and apply a cross-attention mechanism to the intermediate token and to keys and values generated from the first token and the second token to generate the third token.

Aspect 4. The apparatus of any of Aspects 1 to 3, wherein the measurement of movement is based on a cosine similarity between the first token and the second token.

Aspect 5. The apparatus of Aspect 4, wherein the at least one processor is configured to: determine the cosine similarity between the first token and the second token; compare the cosine similarity against a threshold; and compress the first token and the second token based on the cosine similarity being less than the threshold.

Aspect 6. The apparatus of any of Aspects 1 to 5, wherein the at least one processor is configured to process the tokenized video sequence using a first layer of a transformer model, and wherein, to process the third token, the at least one processor is configured to process the third token using a second layer of the transformer model.

Aspect 7. The apparatus of Aspect 6, wherein the at least one processor is configured to: up-sample the third token to generate an additional first token and an additional second token; and process the additional first token and an additional second token using a third layer of the transformer model.

Aspect 8. The apparatus of Aspect 7, wherein the at least one processor is configured to: apply a transpose convolution to the third token to generate intermediate tokens; and apply a cross-attention mechanism to the intermediate tokens and to keys and values generated from the third token to generate the additional first token and additional second token.

Aspect 9. The apparatus of any of Aspects 1 to 8, wherein the tokenized video sequence comprises a third token associated with a second region of the first frame and a fourth token associated with the second region of the second frame, and wherein the at least one processor is configured to: determine, from the third token and the fourth token, an additional measurement of movement of second region between the first frame and the second frame; and based on the additional measurement of movement, compress the third token and the fourth token according to an additional level of compression to generate a fifth token, wherein the additional level of compression is different from a level of compression applied to the first token and the second token.

Aspect 10. A method for generating content, comprising: processing a video to obtain a tokenized video sequence, wherein the video comprises frames and spatially defined regions within the frames, and wherein the tokenized video sequence comprises tokens representing the regions within the frames; identifying a first token associated with a first region of a first frame and a second token associated with a corresponding first region of a second frame; determining, from the first token and the second token, a measurement of movement within the first region between the first frame and the second frame; based on the measurement of movement, compressing the first token and the second token to generate a third token; and processing the third token to generate output content.

Aspect 11. The method of Aspect 10, wherein compressing the first token and the second token comprises down-sampling the first token and the second token to generate the third token.

Aspect 12. The method of any of Aspects 10 or 11, wherein compressing the first token and the second token comprises: applying a convolutional encoder to the first token and the second token to generate an intermediate token; and applying a cross-attention mechanism to the intermediate token and to keys and values generated from the first token and the second token to generate the third token.

Aspect 13. The method of any of Aspects 10 to 12, wherein the measurement of movement is based on a cosine similarity between the first token and the second token.

Aspect 14. The method of Aspect 13, further comprising: determining the cosine similarity between the first token and the second token; comparing the cosine similarity against a threshold; and compressing the first token and the second token based on the cosine similarity being less than the threshold.

Aspect 15. The method of any of Aspects 10 to 14, further comprising processing the tokenized video sequence using a first layer of a transformer model, and wherein, to process the third token, the method further comprising processing the third token using a second layer of the transformer model.

Aspect 16. The method of any of Aspects 10 to 15, further comprising: up-sampling the third token to generate an additional first token and an additional second token; and processing the additional first token and an additional second token using a third layer of a transformer model.

Aspect 17. The method of Aspect 16, further comprising: applying a transpose convolution to the third token to generate intermediate tokens; and applying a cross-attention mechanism to the intermediate tokens and to keys and values generated from the third token to generate the additional first token and additional second token.

Aspect 18. The method of any of Aspects 10 to 17, wherein the tokenized video sequence comprises a third token associated with a second region of the first frame and a fourth token associated with the second region of the second frame, and wherein the method further comprises: determining, from the third token and the fourth token, an additional measurement of movement of second region between the first frame and the second frame; and based on the additional measurement of movement, compressing the third token and the fourth token according to an additional level of compression to generate a fifth token, wherein the additional level of compression is different from a level of compression applied to the first token and the second token.

Aspect 19. A non-transitory computer-readable medium is provided that has stored thereon instructions that, when executed by at least one processor, cause the at least one processor to perform operations according to any of Aspects 10 to 18.

Aspect 20. An apparatus comprising one or more means for performing operations according to any of Aspects 10 to 18.

What is claimed is:

1. An apparatus for generating content, comprising:
at least one memory; and
at least one processor coupled to the at least one memory and configured to:
process a video to obtain a tokenized video sequence, wherein the video comprises frames and spatially defined regions within the frames, and wherein the tokenized video sequence comprises tokens representing the regions within the frames;
identify a first token associated with a first region of a first frame and a second token associated with a corresponding first region of a second frame;
determine, from the first token and the second token, a measurement of movement within the first region between the first frame and the second frame;
based on the measurement of movement, compress the first token and the second token to generate a third token; and
process the third token to generate output content.

2. The apparatus of claim 1, wherein, to compress the first token and the second token, the at least one processor is configured to down-sample the first token and the second token to generate the third token.

3. The apparatus of claim 1, wherein, to compress the first token and the second token, the at least one processor is configured to:
apply a convolutional encoder to the first token and the second token to generate an intermediate token; and
apply a cross-attention mechanism to the intermediate token and to keys and values generated from the first token and the second token to generate the third token.

4. The apparatus of claim 1, wherein the measurement of movement is based on a cosine similarity between the first token and the second token.

5. The apparatus of claim 4, wherein the at least one processor is configured to:
determine the cosine similarity between the first token and the second token;
compare the cosine similarity against a threshold; and
compress the first token and the second token based on the cosine similarity being less than the threshold.

6. The apparatus of claim 1, wherein the at least one processor is configured to process the tokenized video sequence using a first layer of a transformer model, and wherein, to process the third token, the at least one processor is configured to process the third token using a second layer of the transformer model.

7. The apparatus of claim 6, wherein the at least one processor is configured to:
up-sample the third token to generate an additional first token and an additional second token; and
process the additional first token and an additional second token using a third layer of the transformer model.

8. The apparatus of claim 7, wherein the at least one processor is configured to:
apply a transpose convolution to the third token to generate intermediate tokens; and
apply a cross-attention mechanism to the intermediate tokens and to keys and values generated from the third token to generate the additional first token and additional second token.

9. The apparatus of claim 1, wherein the tokenized video sequence comprises a third token associated with a second region of the first frame and a fourth token associated with the second region of the second frame, and wherein the at least one processor is configured to:
determine, from the third token and the fourth token, an additional measurement of movement of second region between the first frame and the second frame; and
based on the additional measurement of movement, compress the third token and the fourth token according to an additional level of compression to generate a fifth token, wherein the additional level of compression is different from a level of compression applied to the first token and the second token.

10. A method for generating content, comprising:
processing a video to obtain a tokenized video sequence, wherein the video comprises frames and spatially defined regions within the frames, and wherein the tokenized video sequence comprises tokens representing the regions within the frames;
identifying a first token associated with a first region of a first frame and a second token associated with a corresponding first region of a second frame;
determining, from the first token and the second token, a measurement of movement within the first region between the first frame and the second frame;
based on the measurement of movement, compressing the first token and the second token to generate a third token; and
processing the third token to generate output content.

11. The method of claim 10, wherein compressing the first token and the second token comprises down-sampling the first token and the second token to generate the third token.

12. The method of claim 10, wherein compressing the first token and the second token comprises:
applying a convolutional encoder to the first token and the second token to generate an intermediate token; and
applying a cross-attention mechanism to the intermediate token and to keys and values generated from the first token and the second token to generate the third token.

13. The method of claim 10, wherein the measurement of movement is based on a cosine similarity between the first token and the second token.

14. The method of claim 13, further comprising:
determining the cosine similarity between the first token and the second token;
comparing the cosine similarity against a threshold; and
compressing the first token and the second token based on the cosine similarity being less than the threshold.

15. The method of claim 10, further comprising processing the tokenized video sequence using a first layer of a transformer model, and wherein, to process the third token, the method further comprising processing the third token using a second layer of the transformer model.

16. The method of claim 10, further comprising:
up-sampling the third token to generate an additional first token and an additional second token; and
processing the additional first token and an additional second token using a third layer of a transformer model.

17. The method of claim 16, further comprising:
applying a transpose convolution to the third token to generate intermediate tokens; and
applying a cross-attention mechanism to the intermediate tokens and to keys and values generated from the third token to generate the additional first token and additional second token.

18. The method of claim 10, wherein the tokenized video sequence comprises a third token associated with a second region of the first frame and a fourth token associated with the second region of the second frame, and wherein the method further comprises:
determining, from the third token and the fourth token, an additional measurement of movement of second region between the first frame and the second frame; and
based on the additional measurement of movement, compressing the third token and the fourth token according to an additional level of compression to generate a fifth token, wherein the additional level of compression is different from a level of compression applied to the first token and the second token.

19. A non-transitory computer-readable medium is provided that has stored thereon instructions that, when executed by at least one processor, cause the at least one processor to:
process a video to obtain a tokenized video sequence, wherein the video comprises frames and spatially defined regions within the frames, and wherein the tokenized video sequence comprises tokens representing the regions within the frames;
identify a first token associated with a first region of a first frame and a second token associated with a corresponding first region of a second frame;
determine, from the first token and the second token, a measurement of movement within the first region between the first frame and the second frame;
based on the measurement of movement, compress the first token and the second token to generate a third token; and
process the third token to generate output content.

20. The non-transitory computer-readable medium of claim 19, wherein, to compress the first token and the second token, the instructions, when executed by the at least one processor, cause the at least one processor to down-sample the first token and the second token to generate the third token.
